(19) United States
(12) Patent Application Publication
(10) Pub. No.: US 2015/0362801 A1
(43) Pub. Date: Dec. 17, 2015

(54) FLAT-PANEL DISPLAY

(71) Applicant: SHARP KABUSHIKI KAISHA, Osaka-shi, Osaka (JP)

(72) Inventors: Tomoyuki ICHIZA, Osaka-shi (JP); Naoki FUKUDA, Osaka-shi (JP); Sunao OHNISHI, Osaka-shi (JP); Akihisa KANEKO, Osaka-shi (JP); Junya YOSHINO, Osaka-shi (JP); Toshiyuki KATOH, Osaka-shi (JP)

(73) Assignee: SHARP KABUSHIKI KAISHA, Osaka-shi, Osaka (JP)

(21) Appl. No.: 14/763,716

(22) PCT Filed: Feb. 13, 2014
(86) PCT No.: PCT/JP2014/053236

§ 371 Date: Jul. 27, 2015

(30) Foreign Application Priority Data
Feb. 14, 2013 (JP) 2013-026554
Feb. 5, 2014 (JP) 2014-020087

(51) Int. Cl. G02F 1/1335

(52) U.S. Cl. CPC G02F 1/133608; G02F 1/133603

(57) ABSTRACT

Provided is a flat-panel display for improving a structure of a shape of a through-hole of a backlight cover that is a resin-made member, which is passed through when making a PWB contact a metal plate member, so that a gasket can be mechanically fixed. This flat-panel display includes: a metal plate member (30) arranged on a rear side of a display panel; a non-conductive plate member (20) arranged so as to face a rear side of the metal plate member (30) and including a through-hole (42); a circuit board (50) arranged so as to face a rear side of the non-conductive plate member (20) ; and a gasket (90) arranged in the through-hole (42) and holding conduction of the metal plate member (30) and the circuit board (50), in which the non-conductive plate member (20) includes a gasket fixation portion (44) formed around the through-hole (42) in a convex shape.

### TECHNICAL FIELD

The present invention relates to a flat-panel display, and relates to, for example, a flat-panel display provided with a function of securing grounding by utilizing a gasket for a circuit board (printed wiring board) and a metal plate.

BACKGROUND ART

For a liquid crystal television of a direct-backlight type model, a configuration in which a resin-made backlight cover (middle cabinet) covers a metal plate member where an LED is arranged as a backlight and a main PWB (printed wiring board) is attached to the resin-made member has been known.

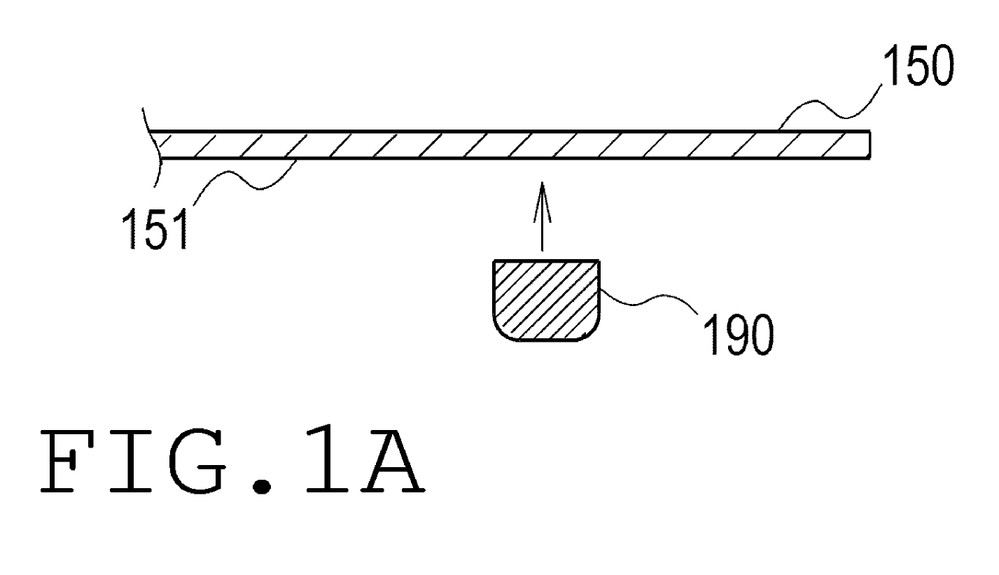

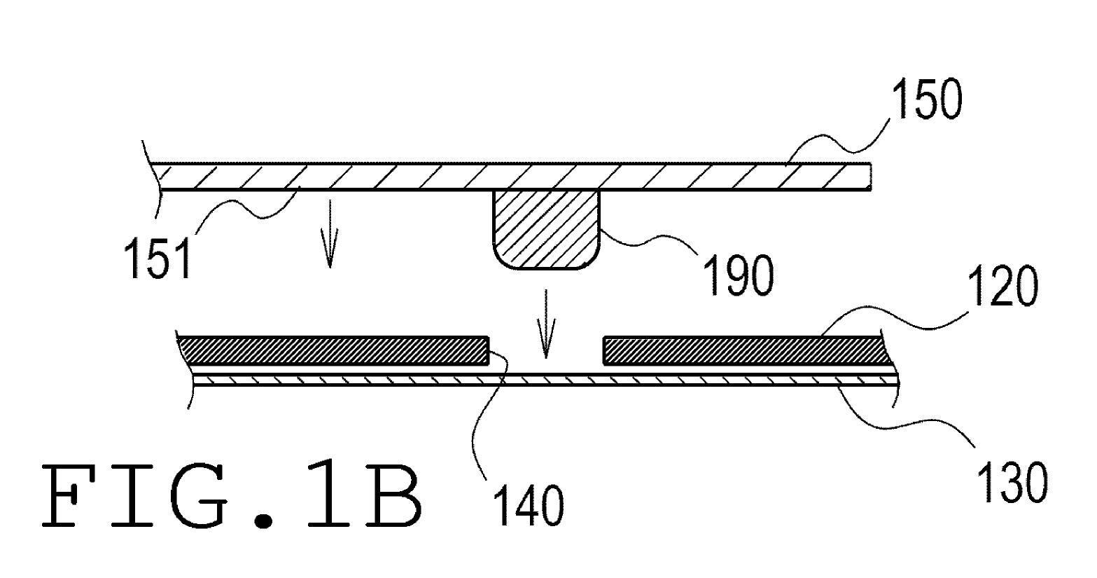

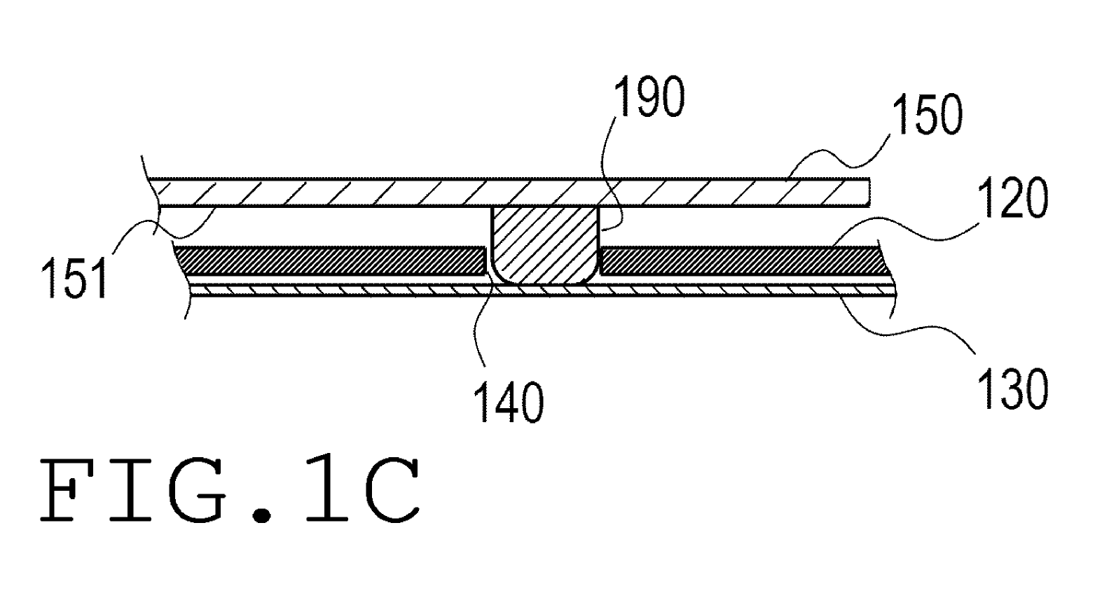

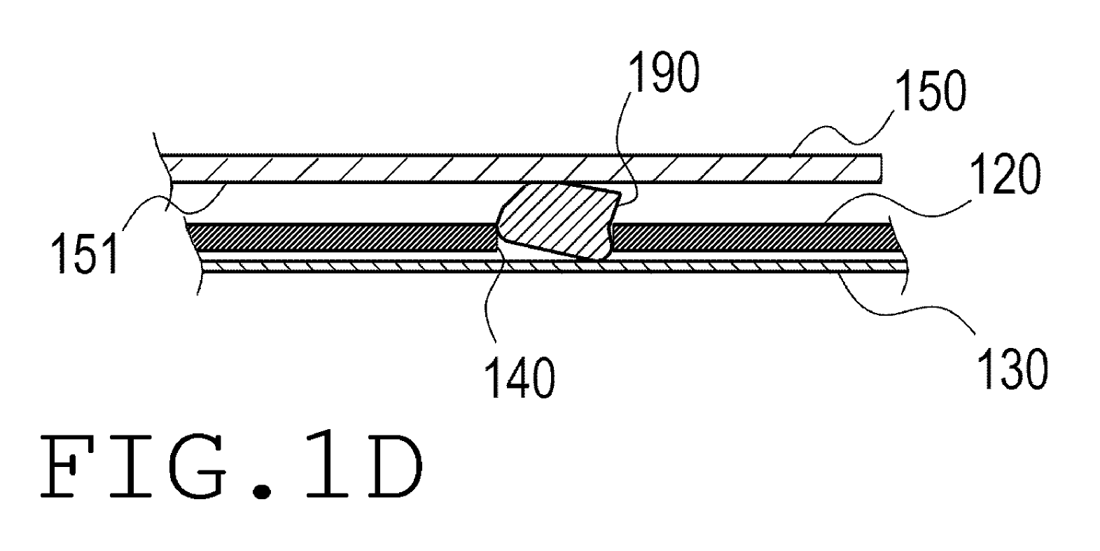

With reference to FIGS. 1, description will be here given for a structure where a gasket 190 is attached with respect to a main PWB 150 in a liquid crystal display. As shown in FIG. 1A, the gasket (conductive member) 190 is fixed to a PWB back surface 151 on which grounding (GND) of the main PWB 150 is formed with a double-sided adhesive tape. Then, as shown in FIG. 1B, in a state where the gasket 190 is fixed to the main PWB 150, in setting of a state where a resin-made back cabinet 120 is arranged on a rear side (upper side in the figure) of a metal plate member 130, the gasket 190 is stuck to a predetermined region of the metal plate member 130 with a double-sided adhesive tape through a gasket through-hole 140 which is formed on the back cabinet 120. As a result thereof, the structure becomes as shown in FIG. 1C, in which the main PWB 150 and the metal plate member 130 appropriately make contact through the gasket 190 and conduction thereof is secured.

This kind of technologies and various ones have been proposed. For example, there is a technology for seeking further thinning of a mobile communication terminal, which incorporates an antenna, while preventing a result of antenna characteristics (refer to PATENT LITERATURE 1). Specifically, a first resin-made cabinet obtained by insert-molding of a first sheet metal and a second resin-made cabinet obtained by insert-molding of a second sheet metal are provided. In addition, a circuit board, on which an antenna is printed, is held between the first resin-made cabinet and the second resin-made cabinet, and the first sheet metal, the second sheet metal and the antenna are electrically connected by a plurality of conductive gaskets.

### CITATION LIST

### Patent Literature

PATENT LITERATURE 1: Japanese Laid-Open Patent Publication No. 2010-109760

### SUMMARY OF INVENTION

### Technical Problem

Meanwhile, the fixation of the gasket 190 is performed to the main PWB 150 and the metal plate member 130 only with the double-sided adhesive tape. Furthermore, since the fixation is performed through the gasket through-hole 140 of the back cabinet 120, in a television adopting such a structure, there are problems such as deterioration of adhesion of the double-sided adhesive tape and variations of a way of sticking at a time of assembling. For example, as shown in FIG. 1D, it is also assumed that the gasket 190 comes off from the gasket through-hole 140 due to deformation or the like. When these problems become tangible, there is a risk that the gasket 190 which makes the main PWB 150 and the metal plate member 130 into conduction causes instability of contact and worsens unnecessary radiation or is in contact with other parts to exert a bad influence. Moreover, in order not to ship such a product to market, labor in an inspection process increases and countermeasure thereagainst has been required.

Moreover, in the technology disclosed in PATENT LITERATURE 1, the gasket is used to thereby electrically connect separated conductive materials for effective use.

Further, positioning is performed by the fixation with the double-sided adhesive tape or making a hole in a middle resin-made cabinet. However, it is impossible to suppress deformation due to compression of the gasket, and there is possibility of being in contact with a region which is not contactable, so that another technology has been desired. Further, in a case where an adhesive material such as a double-sided adhesive tape comes off, there is possibility that the gasket moves due to vibrations or the like, and thus countermeasure thereagainst becomes necessary, so that another technology has been desired.

The present invention is made in view of the circumstances above, and aims to provide a technology which solves the aforementioned problems.

### SOLUTION TO PROBLEM

A flat-panel display of the present invention includes: a metal plate member which is arranged on a rear side of a display panel; a non-conductive plate member which is arranged so as to face a rear side with respect to the metal plate member and which is provided with a through-hole; a circuit board which is arranged so as to face a rear side with respect to the non-conductive plate member; and a gasket which is arranged in the through-hole and which holds conduction of the metal plate member and the circuit board, in which the non-conductive plate member is provided with a gasket fixation portion which is formed around the through-hole in a convex shape.

Moreover, the gasket may be thicker than the gasket fixation portion.

Moreover, the gasket fixation portion may be a wall surface which is formed around the through-hole.

Moreover, the gasket fixation portion may be provided with a claw shape for locking a side surface of the gasket.

Moreover, a hole which is formed in the gasket fixation portion and a bar-shaped body which passes through the hole and sticks through the gasket may be included.

### ADVANTAGEOUS EFFECT OF INVENTION

According to the present invention, it is possible to provide a technology of improving a structure of a shape of a through-hole of a backlight cover (middle cabinet) that is a resin-made member, which is passed through when making a circuit board and a metal plate member in contact, so that a gasket is able to be mechanically fixed.

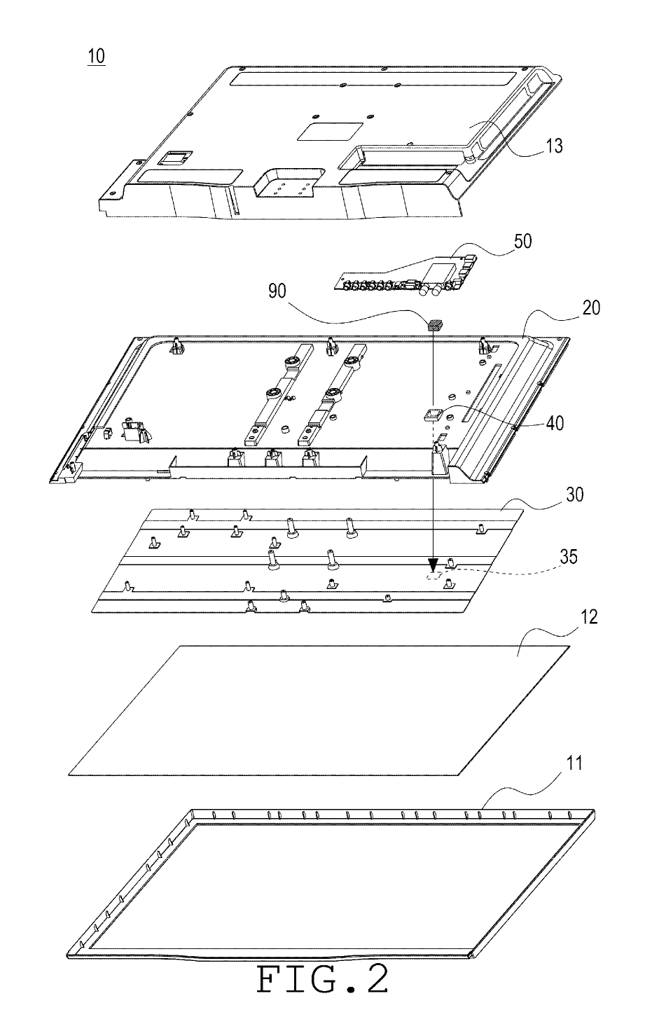

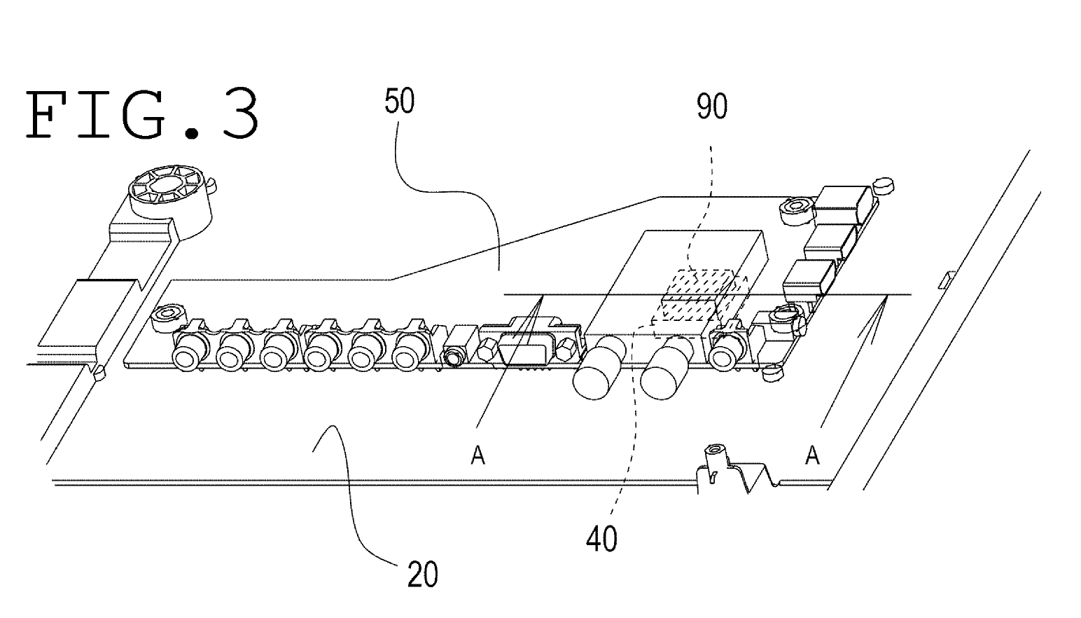

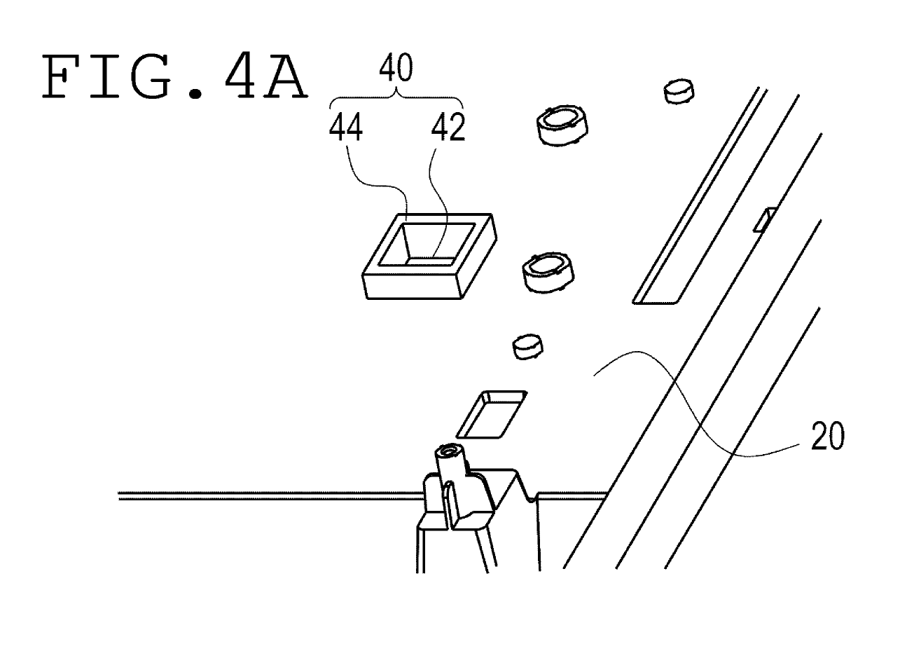

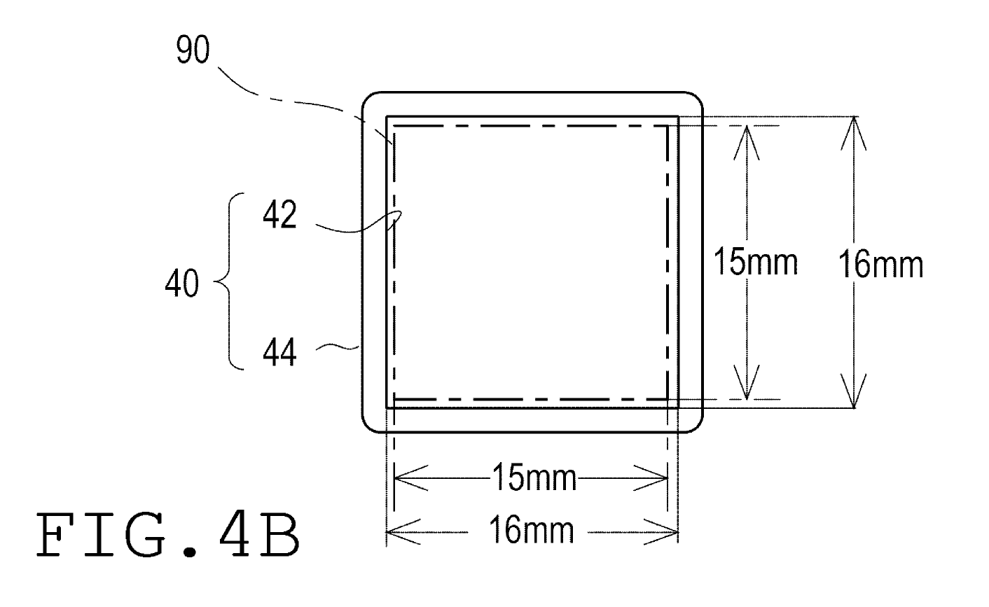

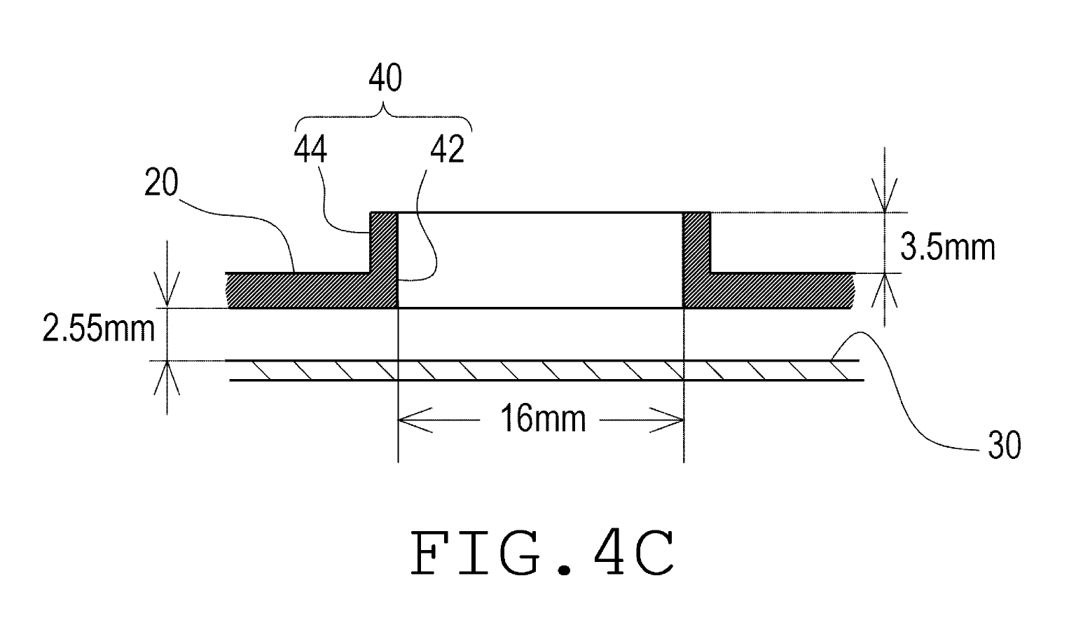

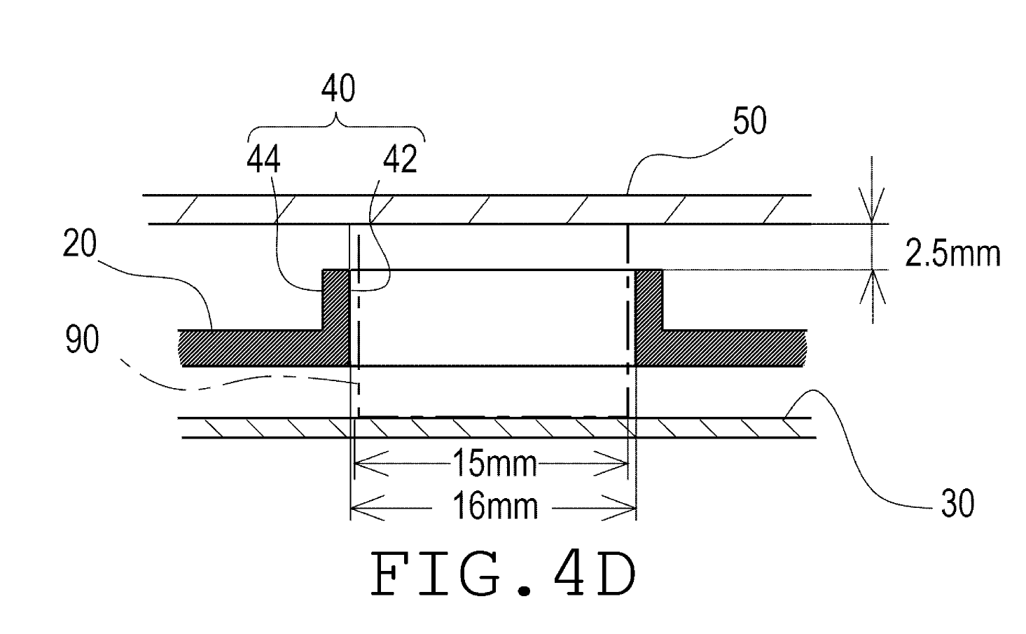

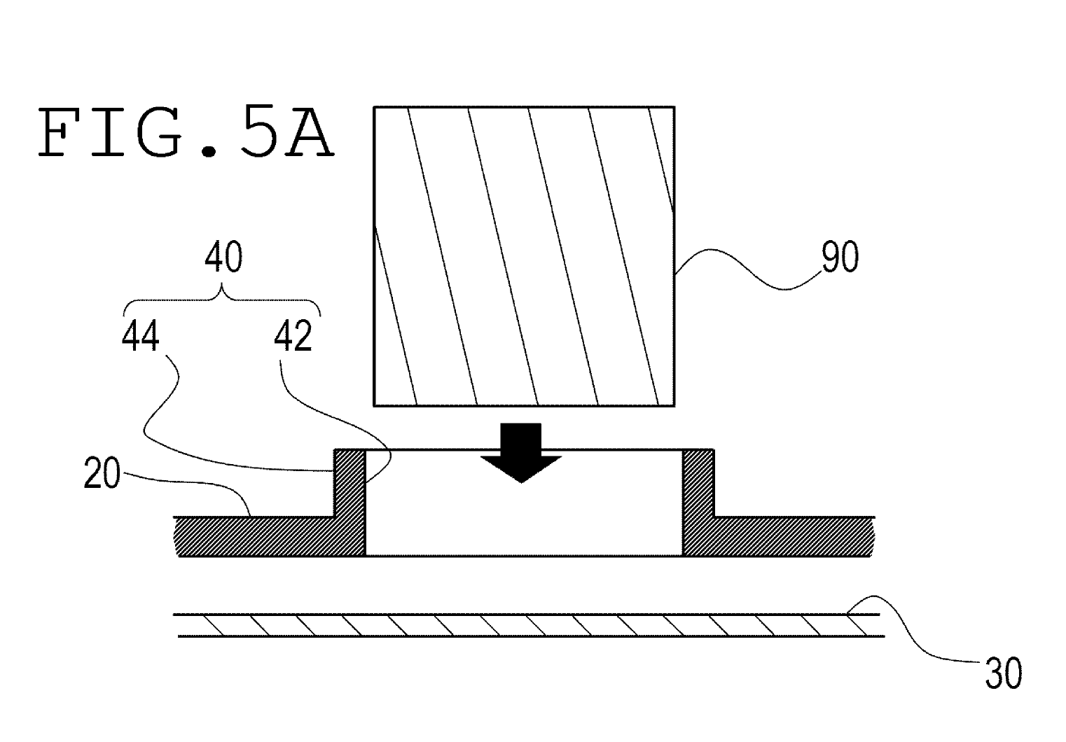

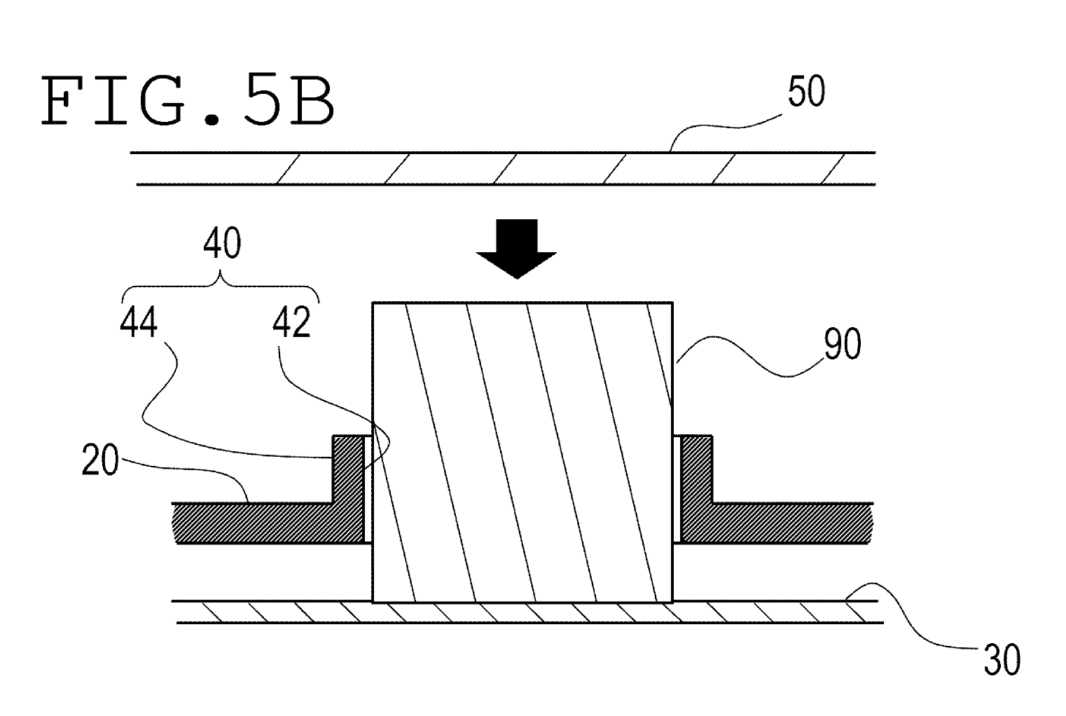

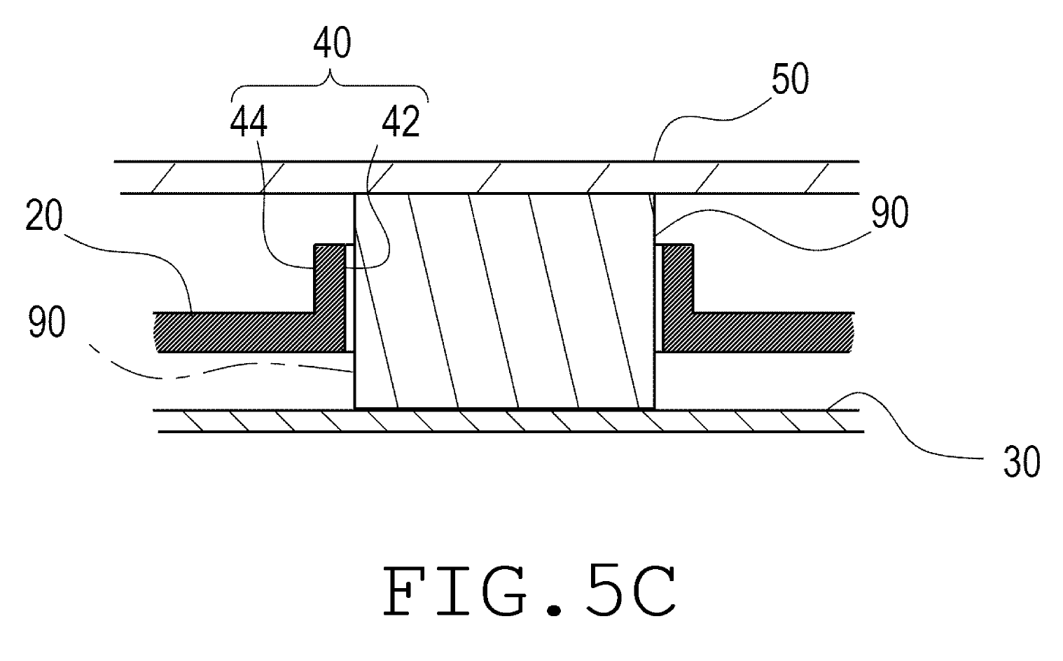

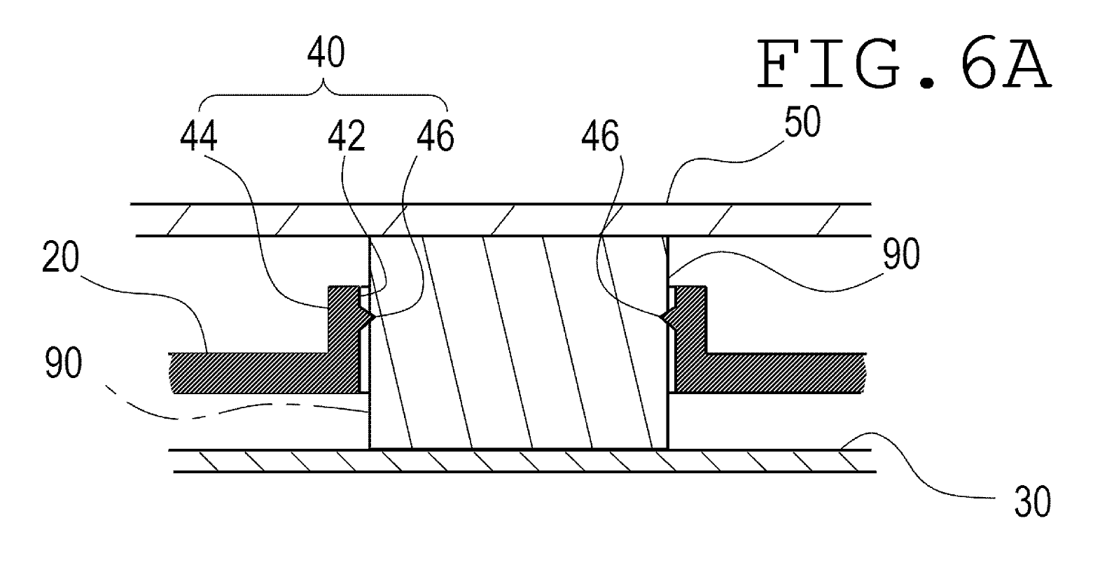

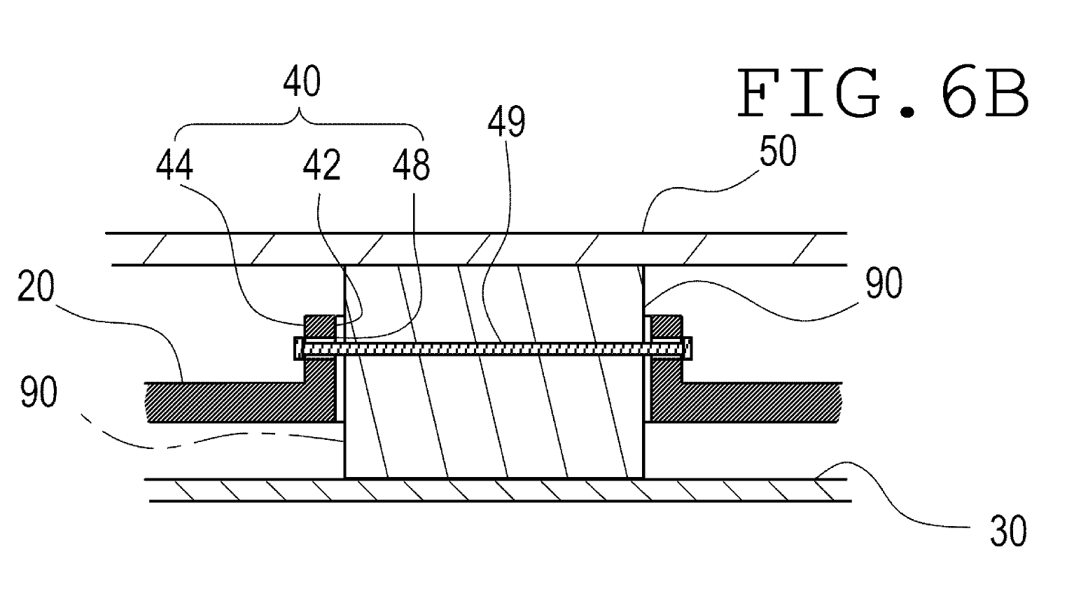

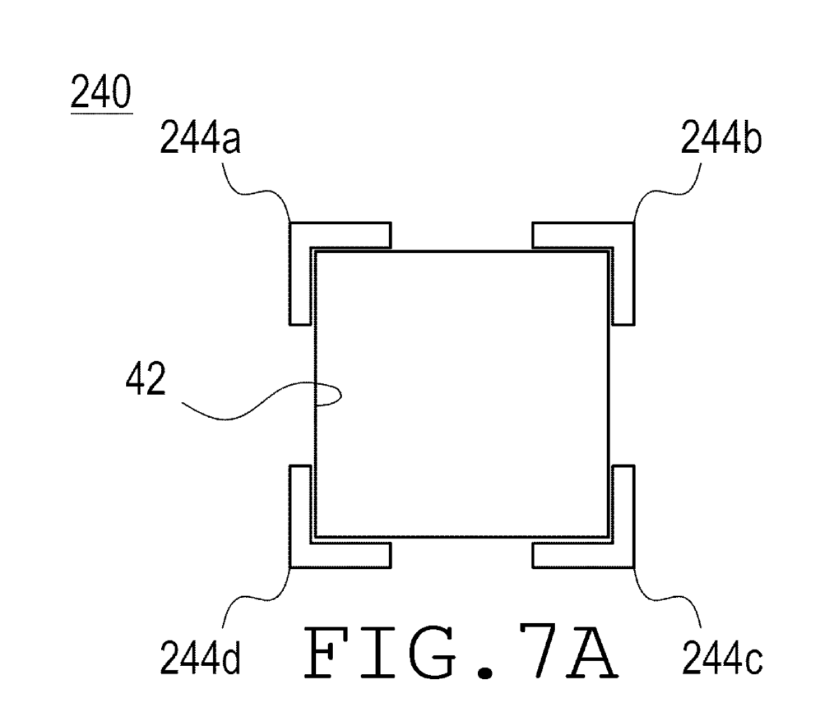

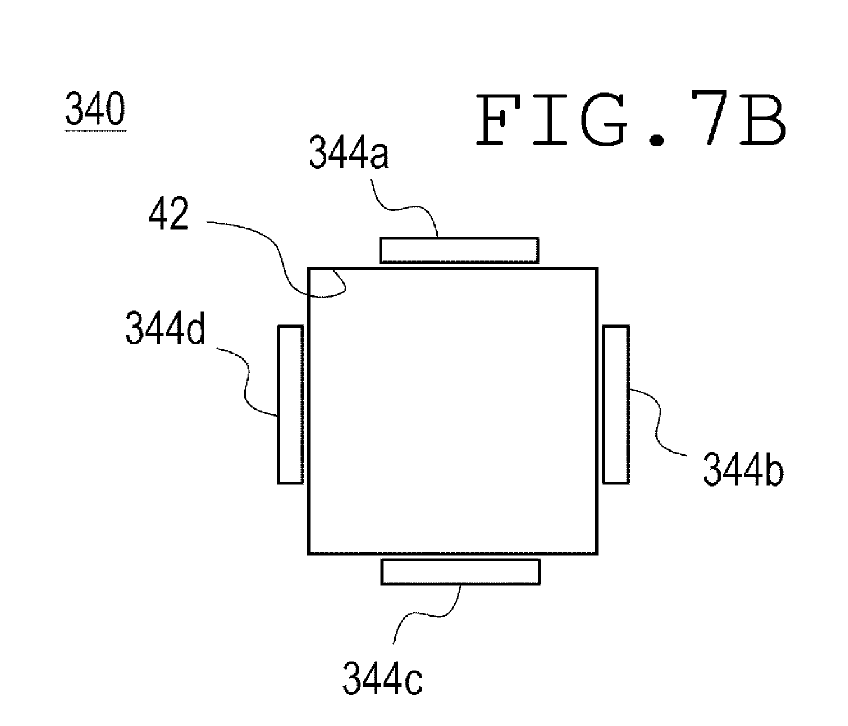

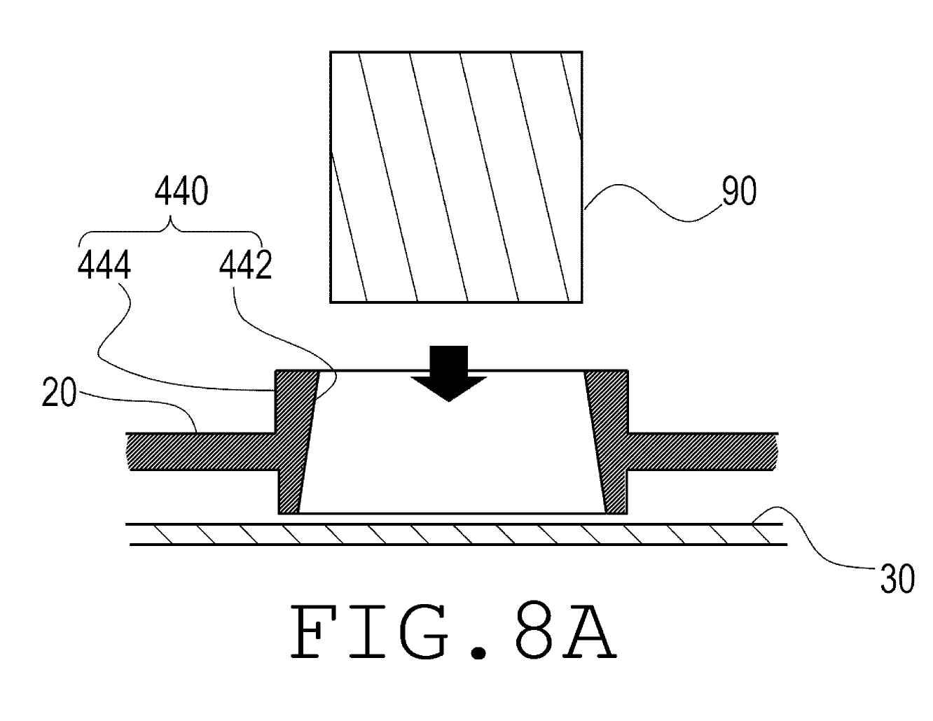

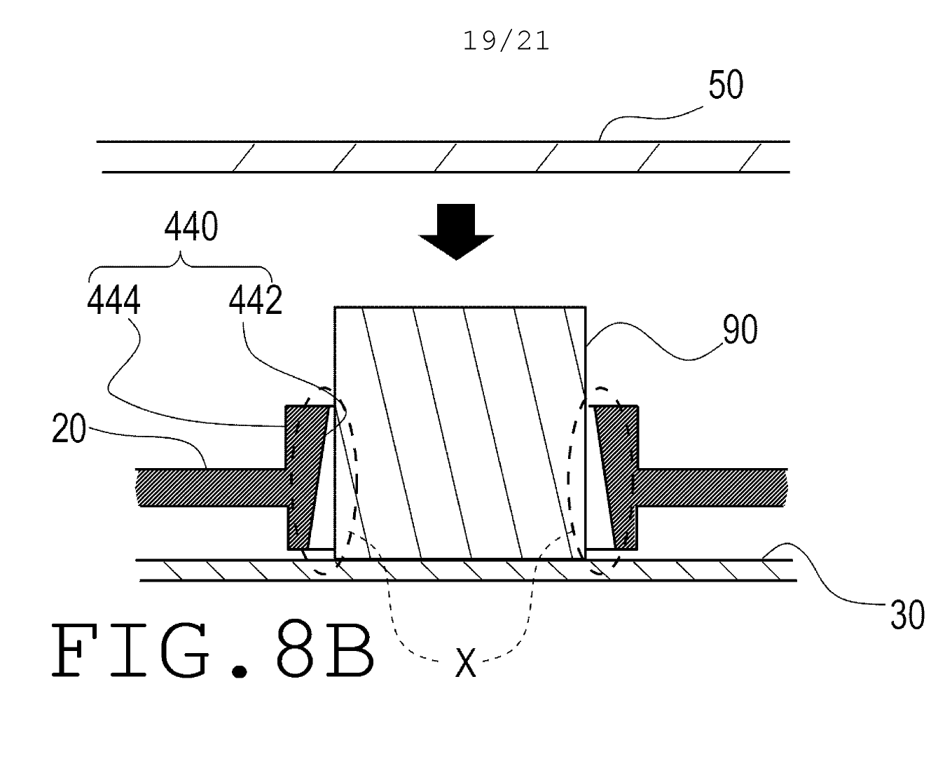

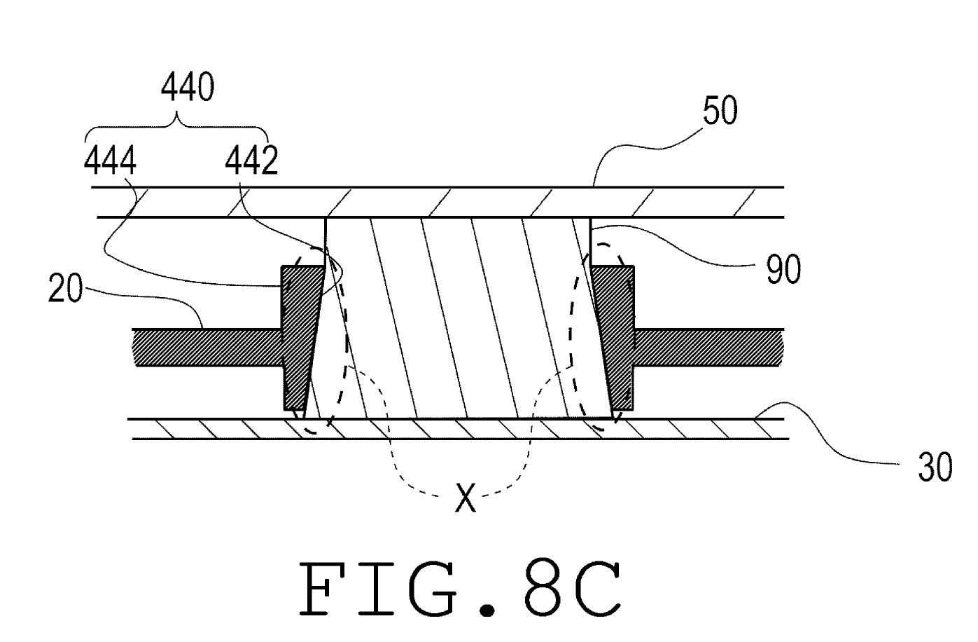

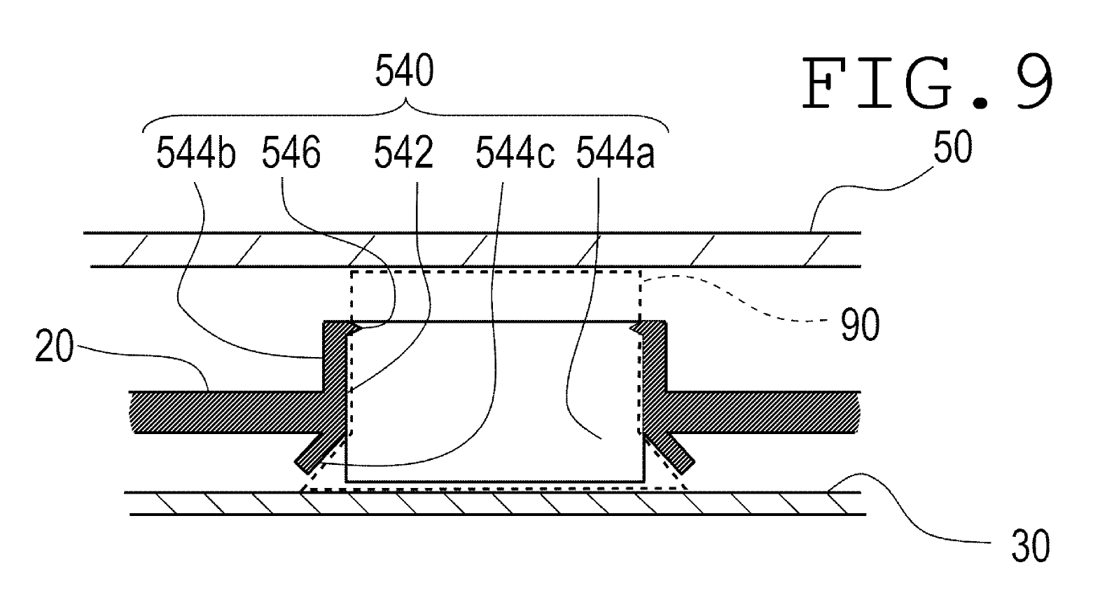

### BRIEF DESCRIPTION OF DRAWINGS

[FIGS. 1] are views showing a grounding structure of a metal plate member of a backlight and a main PWB by a gasket in a liquid crystal television according to a background art.

[FIG. 2] is an exploded perspective view of a liquid crystal television according to a first embodiment.

[FIG. 3] is a view showing a grounding structure of a metal plate member of a backlight and a PWB by a gasket in the liquid crystal television according to the first embodiment.

[FIGS. 4] are views focusing on a gasket arrangement portion of the grounding structure according to the first embodiment.

[FIGS. 5] are views showing procedure of forming the grounding structure by the gasket according to the first embodiment.

[FIGS. 6] are views showing arrangement of a grounding structure by a gasket according to a second embodiment.

[FIGS. 7] are views showing a gasket arrangement portion according to a third embodiment.

[FIGS. 8] are views showing a gasket arrangement portion according to a fourth embodiment.

[FIG. 9] is a view showing a gasket arrangement portion according to a fifth embodiment.

### DESCRIPTION OF EMBODIMENTS

Next, description will be specifically given for forms for implementing the present invention (hereinafter, simply referred to as “embodiments”) with reference to drawings.

### First Embodiment

FIG. 2 is an exploded perspective view of a liquid crystal television 10 according to the present embodiment, which is schematically expressed so that a front side and a rear side are arranged in a lower side of the figure and an upper side of the figure, respectively.

As shown in the figure, a backlight unit 30 is arranged so as to face a rear side (upper side in the figure) of a display panel 12. Moreover, a front cabinet 11 is arranged in a forward side (lower side in the figure) of the display panel 12.

The backlight unit 30 is a so-called direct-type backlight, and a plurality of LEDs are arranged on a frontward side of a metal plate member thereof as a light source. Further, on a rear side of the backlight unit 30, a resin-made backlight cabinet 20 is arranged so as to face thereto. Then, a main PWB 50 is arranged so as to face thereto in a predetermined region on a further rear side thereof. Furthermore, on a rear side of the backlight cabinet 20 to which the main PWB 50 is attached, a rear cabinet 13 is arranged so as to face thereto.

A gasket arrangement portion 40 by which the backlight cabinet 20 is communicated back and forth is provided in the backlight cabinet 20, and description thereof will be given below in detail. A gasket 90 having a predetermined size is arranged in this gasket arrangement portion 40, and a predetermined rectangular region 35 of the metal plate member of the backlight unit 30 and a predetermined grounding circuit region (ground pattern) of the main PWB 50 are electrically connected.

A perspective view of FIG. 3 is shown by focusing on the backlight cabinet 20 and the main PWB 50.

As described above, the main PWB 50 is arranged on and fixed to the rear surface of the backlight cabinet 20. At this time, the main PWB 50 is grounded with respect to the backlight unit 30 by the gasket 90. Various LSIs for processing, input/output terminals, and the like are arranged on a top surface of a back side (upper side of the figure) of the main PWB 50.

Description will hereinafter be given for a structure of grounding with reference to FIGS. 4 and FIGS. 5. Here, FIGS. 4 are views focusing on the gasket arrangement portion of the grounding structure. Moreover, FIGS. 5 are views showing procedure of forming the grounding structure by the gasket, in which particularly FIG. 5C corresponds to a sectional view taken along A-A of FIG. 3.

As illustrated, the gasket arrangement portion 40 for arranging the gasket 90 therein is formed on the backlight cabinet 20. Note that, the gasket 90 is a regular hexahedron having a size of 15 mm×15 mm×15 mm and has cushioning property which allows being pressed down by a fixed amount.

The gasket arrangement portion 40 is formed by a gasket through opening 42 which is a quadrilateral and a wall portion 44 surrounding four sides of this gasket through opening 42. Note that, from a viewpoint of consideration of falling of the gasket 90 due to aged deterioration or the like, the wall portion 44 only needs to be formed mainly around a region corresponding to a lower side of the liquid crystal television 10 when being used in a standing manner, and does not need to be formed in a region corresponding to an upper side thereof. However, when considering a case where the gasket 90 is shifted and deformed in accordance with movement of the main PWB 50 or the like, it is preferable to be formed also in the region on the upper side. Moreover, it is not necessary to be formed so as to have a complete wall surface, and a plurality of pin-shaped structures may be used.

Here, the gasket through opening 42 has a size of 16 mm×16 mm. Accordingly, in a state where the gasket 90 is arranged, a gap of 0.5 mm is formed in upper and lower, and right and left sides between the gasket 90 and the gasket through opening 42.

The wall portion 44 is formed in a convex shape having a height of 3.5 mm so as to surround the gasket through opening 42 and so as to have a predetermined width on the rear side. Note that, a thickness of a plate part of the backlight cabinet 20 is 3.0 mm. Moreover, in a state where the liquid crystal television 10 has been properly assembled, a distance between the backlight unit 30 (metal plate member 32) and the backlight cabinet 20 is 2.55 mm. Furthermore, a distance between a tip portion of the wall portion 44 and the main PWB 50 is 2.5 mm. That is, a distance between the metal plate member 32 on the rear side of the backlight unit 30 and the main PWB 50 is 11.55 mm, and the gasket 90 is fixed in a state of being crushed by 3.45 mm. Note that, on a frontward side of the main PWB 50 (a lower side in the figure and a side of a surface facing the backlight cabinet 20), the rectangular region 35 of laterally 18 mm×longitudinally 15 mm is secured as a grounding region in a region to which the gasket 90 is fixed.

Here, description will be given for procedure of arranging the grounding structure by the gasket.

First, as shown in FIG. 5A, in a state where the backlight cabinet 20 is properly arranged on the rear side of the backlight unit 30, the gasket 90 is inserted into the gasket arrangement portion 40 and arranged on the predetermined region 35 for grounding of the backlight unit 30. At this time, the gasket 90 is keeping an original form thereof.

Subsequently, as shown in FIG. 5B, the main PWB 50 is arranged from above the gasket 90, that is, from the rear side. At this time, the distance between the main PWB and the backlight cabinet 20 is set as 2.5 mm, as described with FIG. 4D. Accordingly, the main PWB 50 is fixed to the backlight cabinet 20 as shown in FIG. 5C, and thereby the gasket 90 is pressed down by a predetermined amount to be fixed. A length of the gasket 90 which is projecting from an upper end of the wall portion 44 of the gasket arrangement portion 40 changes into 5.5 mm from 8.95 mm before being crushed.

As above, according to the present embodiment, mechanical strength of fixation of the gasket is secured. That is, a width and an area which face side surfaces of the gasket 90 increase. Thus, it is possible to control deformation of a shape of the gasket 90 at a time of attaching work of the gasket 90. Accordingly, suppression of shift due to vibrations or the like and positioning at the time of attaching work of the gasket 90 become easy. Moreover, stable contact and conduction of the main PWB 50 and the metal plate member (backlight unit 30) on which the LEDs are arranged are secured, thus making it possible to suppress worsening of unnecessary radiation.

### Second Embodiment

FIGS. 6 are views showing the gasket arrangement portion 40 according to a second embodiment. For example, as shown in FIG. 6A, a claw-shaped locking structure 46 may be formed on an inner surface of the wall portion 44. The fixation of the gasket 90 becomes even firmer. The locking structure 46 may be formed throughout a whole circumference of the inner surface, or may be formed only in a partial region. Moreover, a size of the locking structure 46 is set in consideration of balance of workability at a time of arranging the gasket 90, a deformation amount at a time of being crushed, and fixing force, and is, for example, about 0.5 mm which corresponds to the aforementioned gap between the gasket 90 and the gasket arrangement portion 40. Moreover, as shown in FIG. 6B, holes 48 may be provided at two sites on the wall portion 44, which face each other, and a bar for fixation 49 may be attached to these holes 48 so as to stick and pass through the gasket 90. Note that, not one but a plurality of the bars for fixation 49 passing through the gasket 90 may be provided, and a configuration of not passing through may be used.

In addition, the height of the wall portion 44 of the gasket arrangement portion 40 may be lowered only on a surface of a cushioning part of the gasket 90, which is not particularly illustrated. By creating an escape place for the cushion of the crushed gasket 90, when being deformed, it is possible to prevent the gasket 90 from being in contact with other than the ground pattern.

### Third Embodiment

FIGS. 7 are views showing gasket arrangement portions 240 and 340 according to a third embodiment, which are views corresponding to FIG. 4B.

The gasket arrangement portion 240 shown in FIG. 7A is provided with first to fourth protruding portions 244a to 244d which are formed in four corners of the gasket through opening 42 as a configuration corresponding to the above-described wall portion 44 which surrounds a circumference of the gasket through opening 42. The first to fourth protruding portions 244a to 244d have an L-shaped rib protrusion structure in a top view.

The gasket arrangement portion 340 shown in FIG. 7B is provided with first to fourth wall portions 344a to 344d which have a plate shape (rib shape) in a vicinity of the four sides of the gasket through opening 42 as a configuration corresponding to the above-described wall portion 44 which surrounds the circumference of the gasket through opening 42. Contrary to the configuration of FIG. 7A, provided is the configuration that the four corners of the above-described wall portion 44 are removed.

With these structures, in a case where the gasket is crushed and deformed, the crushed part fits into spaces at four sites in which the first to fourth protruding portions 244a to 244d or the first to fourth wall portions 344a to 344d are not formed, so that a position maintaining function of the gasket 90 excellently acts with respect to vibrations in every direction.

### Fourth Embodiment

FIGS. 8 are sectional side views showing a gasket arrangement portion 440 according to a fourth embodiment, which correspond to FIGS. 5. In the gasket arrangement portion 440, a wall portion 444 which projects upward and downward, that is, projects to both sides of the main PWB 50 and the backlight unit 30 so as to surround a gasket through opening 442 is formed. Then, in an inner wall surface of the wall portion 444, the gasket through opening 442 is formed so as to widen toward the side of the backlight unit 30. That is, the gasket through opening 442 is to be a truncated quadrangular pyramid. A size of an upper side of the gasket through opening 442 is approximately same as that of an external form of the gasket 90.

Like in FIG. 8A, the gasket 90 is inserted into the gasket through opening 442 from above, which comes to be in a state of FIG. 8B. In the state of FIG. 8B, a predetermined space X is formed between the wall portion 444 and the gasket 90. Then, like in FIG. 8C, when the main PWB is attached and the gasket 90 is crushed and deformed, the deformed part is to expand in the space X between the wall portion 444 and the gasket 90. As a result thereof, the deformed part is not to protrude to the side of the main PWB 50. Accordingly, the gasket 90 does not exert a bad influence with respect to parts or wires mounted on the main PWB 50.

### Fifth Embodiment

FIG. 9 is a sectional side view showing a gasket arrangement portion 540 according to a fifth embodiment. This gasket arrangement portion 540 has an upper-side wall portion 544a which is formed so as to surround an upper side of a gasket through opening 542, and first lower-side wall portions 544b and second lower-side wall portions 544c which are formed in a lower side thereof. The upper-side wall portion 544a has a structure same as that of the wall portion 40 shown in FIG. 6A, and a claw-shaped locking structure 546 is formed in an upper side of an inner surface of the upper-side wall portion 544a. In the gasket 90 which is locked by the locking structure 546, a predetermined notch or a concave shape for determining a locking position is formed.

Two wall portions in a far side and a near side in the figure (not shown) correspond to the first lower-side wall portions 544b. These first lower-side wall portions 544b are formed in a rib shape extending perpendicularly in a lower direction only by a predetermined length. Two right and left wall portions correspond to the second lower-side wall portions 544c in the figure. These second lower-side wall portions 544c have a structure of widening toward an external direction.

With these structures, when the gasket 90 attached to the gasket arrangement portion 540 is pressed down and deformed, the deformed part is guided by the second lower-side wall portions 544c widening toward the external direction.

As above, description has been given for the present invention based on the embodiments. These embodiments are only exemplary and those skilled in the art could understand that, by combining each of the components thereof, etc., various modifications are possible, and such modifications are also within the scope of the present invention.

### Reference Signs List

10 liquid crystal television
11 front cabinet
12 display panel
13 rear cabinet
20 backlight cabinet
30 backlight unit
32 metal plate member
35 region
40, 240, 340, 440, 540 gasket arrangement portion
42, 442, 542 gasket through opening
44, 444 wall portion
46, 546 locking structure
48 hole
49 bar for fixation
50 main PWB
90 gasket
244a to 244d first to fourth protruding portion
344a to 344d first to fourth wall portion
544a upper-side wall portion
544b first lower-side wall portion
544c second lower-side wall portion

1. A flat-panel display, comprising:
a metal plate member which is arranged on a rear side of a display panel;
a non-conductive plate member which is arranged so as to face a rear side with respect to the metal plate member and which is provided with a through-hole;
a circuit board which is arranged so as to face a rear side with respect to the non-conductive plate member; and
a gasket which is arranged in the through-hole and which holds conduction of the metal plate member and the circuit board, wherein
the non-conductive plate member is provided with a gasket fixation portion which is formed around the through-hole in a convex shape.

2. The flat-panel display according to claim 1, wherein the gasket is thicker than the gasket fixation portion.

3. The flat-panel display according to claim 1, wherein the gasket fixation portion is a wall surface which is formed around the through-hole.

4. The flat-panel display according to claim 1, wherein the gasket fixation portion is provided with a claw shape for locking a side surface of the gasket.

5. The flat-panel display according to claim 1, wherein a hole which is formed in the gasket fixation portion and
a bar-shaped body which passes through the hole and sticks through the gasket are included.
